(19) United States
(12) Patent Application Publication
(10) Pub. No.: US 2011/0096060 A1
(43) Pub. Date: Apr. 28, 2011

(54) PLASMA DISPLAY DEVICE

(76) Inventor: Yoshiho Seo, Yokohama (JP)

(21) Appl. No.: 12/866,718

(22) PCT Filed: Mar. 17, 2009
(86) PCT No.: PCT/JP2009/055203

§ 371 Date: Jan. 6, 2011

(51) Int. Cl. G09G 5/00; G09G 3/28

(52) U.S. Cl. 345/212; 345/60

(57) ABSTRACT

A plasma display device is provided which includes: a first common electrode (Xi) that is supplied with a constant voltage in a display discharge period; a first scan electrode (Yi) that is provided in parallel to the first common electrode and supplied with a display discharge pulse in the display discharge period to perform display discharge between the first scan electrode and the first common electrode; and a first address electrode (Aj) that is provided in a manner to intersect the first common electrode and the first scan electrode, wherein the capacitance (Cax) between the first common electrode and the first address electrode is larger than the capacitance (Cay) between the first scan electrode and the first address electrode.

### TECHNICAL FIELD

The present invention relates to a plasma display device.

### BACKGROUND ART

To reduce the cost of a plasma display circuit by simplifying a drive circuit thereof, a technique of placing a drive circuit for display discharge only on a scan electrode side is under consideration.

Japanese Laid-open Patent Publication No. 2008-145899 describes a mode of fixing the electrode on one side of the panel to a constant potential and alternately applying positive and negative voltages to the electrode on the other side of the panel to drive the panel in a period when light emission of an AC-type PDP is sustained.

Besides, Japanese Laid-open Patent Publication No. 2000-242223 describes a plasma display panel having a pair of display electrodes formed substantially parallel to each other and an address electrode intersecting the display electrode pair, wherein the address electrode is brought into a floating state in a display discharge period in which the pair of display electrodes discharge to perform display.
Patent Document 1: Japanese Laid-open Patent Publication No. 2008-145899
Patent Document 2: Japanese Laid-open Patent Publication No. 2000-242223

### SUMMARY OF THE INVENTION

An object of the present invention is to provide a plasma display device capable of reducing a reactive power due to a current flowing between an address electrode and a scan electrode in a display discharge period.

According to an aspect of the present invention, a plasma display device is provided which includes: a first common electrode that is supplied with a constant voltage in a display discharge period; a first scan electrode that is provided in parallel to the first common electrode and supplied with a display discharge pulse in the display discharge period to perform display discharge between the first scan electrode and the first common electrode; and a first address electrode that is provided in a manner to intersect the first common electrode and the first scan electrode, wherein the capacitance between the first common electrode and the first address electrode is larger than the capacitance between the first scan electrode and the first address electrode.

### BRIEF DESCRIPTION OF THE DRAWINGS

FIG. 1 is a diagram illustrating a configuration example of a plasma display device according to a first embodiment of the present invention;

FIG. 2 is a sectional view illustrating a configuration example of a plasma display panel;

FIG. 3 is a diagram illustrating a configuration example of one frame of an image;

FIG. 4 illustrates voltage waveforms of a scan electrode, a common electrode and an address electrode in a display discharge period;

FIG. 5A is a circuit diagram illustrating a configuration example of the plasma display device, and FIG. 5B is a diagram of voltage waveforms of the scan electrode, the common electrode and the address electrode in the display discharge period;

FIG. 6A is a diagram illustrating a configuration example of the plasma display device according to the first embodiment of the present invention, and FIG. 6B is a diagram of voltage waveforms of the scan electrode, the common electrode and the address electrode in the display discharge period;

FIG. 7A is a plan view illustrating a configuration example of a plasma display device according to a second embodiment of the present invention, and FIG. 7B is a sectional view of the plasma display device;

FIG. 8A is a plan view illustrating a configuration example of a plasma display device according to a third embodiment of the present invention, and FIG. 8B is a sectional view of the plasma display device;

FIG. 9A is a plan view illustrating a configuration example of a plasma display device according to a fourth embodiment of the present invention, and FIG. 9B is a sectional view of the plasma display device;

FIG. 10A is a plan view illustrating a configuration example of a plasma display device according to a fifth embodiment of the present invention, FIG. 10B is a sectional view of the plasma display device, and FIG. 10C is a diagram illustrating the operation of a switch;

FIG. 11A is a plan view illustrating configuration example of a plasma display device according to a sixth embodiment of the present invention, and FIG. 11B is a sectional view of the plasma display device; and

FIG. 12A is a plan view illustrating a configuration example of a plasma display device according to a seventh embodiment of the present invention, and FIG. 12B is a sectional view of the plasma display device.

### DETAILED DESCRIPTION OF THE PREFERRED EMBODIMENTS

### First Embodiment

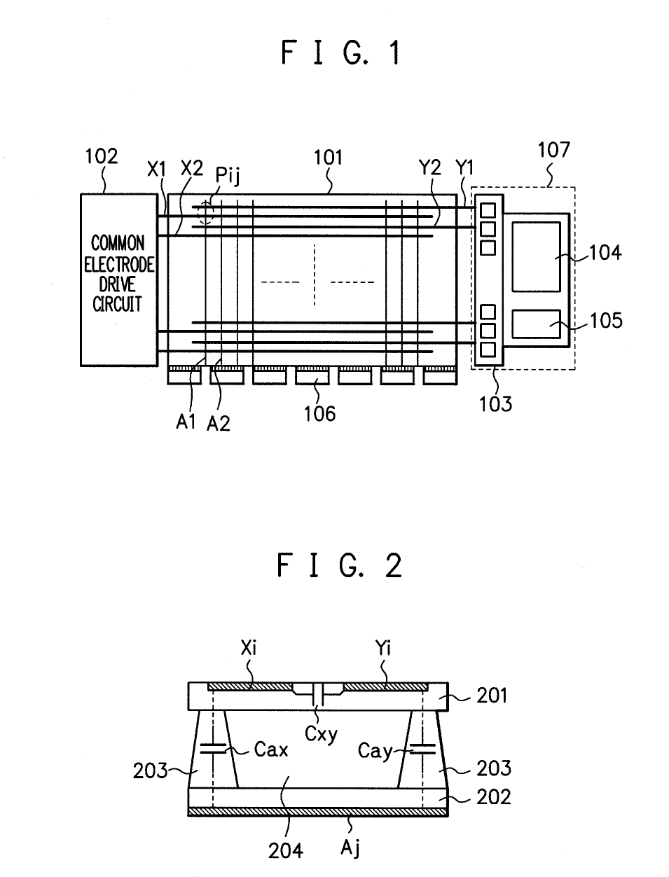

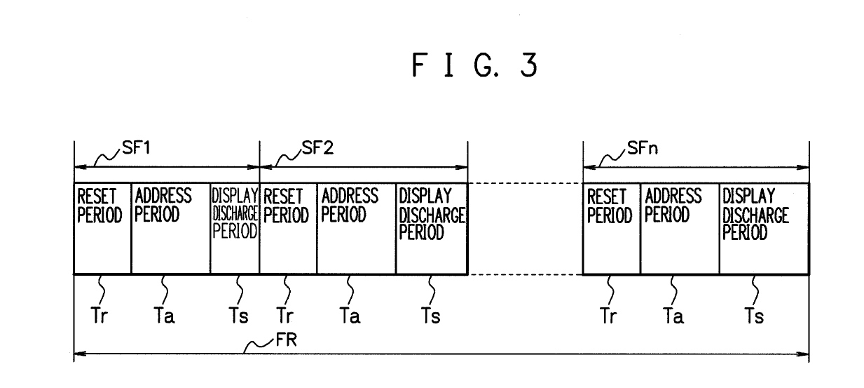

FIG. 1 is a diagram illustrating a configuration example of a plasma display device according to a first embodiment of the present invention. A common electrode drive circuit 102 supplies a predetermined voltage to a plurality of common electrodes X1, X2, . . . . Hereinafter, the common electrodes X1, X2, . . . are individually or generically called a common electrode Xi, the i meaning a subscript. A scan electrode drive circuit 107 has a reset circuit 105, a scan circuit 103 and a display discharge circuit 104, and supplies a predetermined voltage to a plurality of scan electrodes Y1, Y2, . . . . Hereinafter, the scan electrodes Y1, Y2, . . . are individually or generically called a Y electrode Yi, the i meaning a subscript. The reset circuit 105 generates a voltage in a reset period Tr in FIG. 3. The scan circuit 103 generates a voltage in an address period Ta. The display discharge circuit 104 generates a voltage in a display discharge period Ts in FIG. 3. An address electrode drive circuit 106 supplies a predetermined voltage to a plurality of address electrodes A1, A2, . . . . Hereinafter, the address electrodes A1, A2, . . . are individually or generically called an address electrode Aj, the j meaning a subscript.

In a plasma display panel 101, the scan electrodes Yi and the common electrodes Xi form rows extending in parallel in a horizontal direction, and the address electrodes Aj form columns extending in a vertical direction. The scan electrodes Yi and the common electrodes Xi are arranged alternately in the vertical direction. The scan electrodes Yi and the address electrodes Aj form a two-dimensional matrix with i rows and j columns. A display cell Pij is formed by an intersection point of the scan electrode Yi and the address electrode Aj, and the common electrode Xi correspondingly adjacent thereto. This display cell Pij corresponds to a pixel, and the plasma display panel 101 can display a two-dimensional image.

FIG. 2 is a sectional view illustrating a configuration example of a plasma display panel 101. Under the common electrode Xi and the scan electrode Yi, a dielectric film 201 for insulating them from a discharge space 204 is deposited. Meanwhile, on the address electrode Aj, a dielectric film 202 is deposited. On the inner surface of a rib 203, a phosphor of red, blue or green is applied for each display cell. The phosphor is exited by a display discharge between the common electrode Xi and the scan electrode Yi to generate light of each color. A Ne+Xe Penning gas or the like is sealed in the discharge space 204. A capacitance Cxy is the capacitance between the common electrode Xi and the scan electrode Yi. A capacitance Cax is the capacitance between the common electrode Xi and the address electrode Aj. A capacitance Cay is the capacitance between the scan electrode Yi and the address electrode Aj.

FIG. 3 is a diagram illustrating a configuration example of one frame FR of an image. The image is formed at, for example, 60 frames per second. The one frame FR is formed by a first subframe SF1, a second subframe SF2, . . . , and an n-th subframe SFn. This n is, for example, 10 and corresponds to the number of gradation bits. The subframes SF1, SF2, and so on are individually or generically called as a subframe SF.

Each subframe SF is composed of a reset period Tr, an address period Ta, and a display discharge period Ts. In the reset period Tr, the display cells Pij are initialized by applying predetermined voltages to the common electrodes Xi and the scan electrodes Yi.

In the address period Ta, light emission or non-light emission of each of the display cells Pij can be selected by an address discharge between the address electrode Aj and the scan electrode Yi. More specifically, in the address period Ta, a scan pulse is sequentially scanned and applied to the scan electrodes Y1, Y2, . . . , and an address pulse is applied to the address electrode Aj corresponding to the scan pulse, whereby the display pixel is selected. When the address pulse for the address electrode Aj is generated corresponding to the scan pulse for the scan electrode Yi, the display cell Pij of the scan electrode Yi and the common electrode Xi is selected. If the address pulse for the address electrode Aj is not generated corresponding to the scan pulse for the scan electrode Yi, the display cell Pij of the scan electrode Yi and the common electrode Xi is not selected. When the address pulse is generated corresponding to the scan pulse, an address discharge between the address electrode Aj and the scan electrode Yi is generated. With this as a pilot flame, a discharge between the common electrode Xi and the scan electrode Yi is generated, negative charges are accumulated on the common electrode Xi, and positive charges are accumulated on the scan electrode Yi.

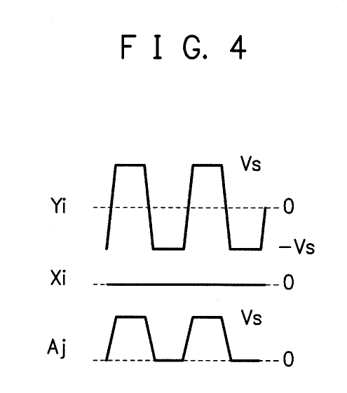

FIG. 4 illustrates voltage waveforms of the scan electrode Yi, the common electrode Xi and the address electrode Aj in the display discharge period Ts. In the display discharge period Ts, 0V is applied to the common electrode Xi and a display discharge pulse is applied to the scan electrode Yi to perform display discharge and light emission between the common electrode Xi and the scan electrode Yi of a selected display cell Pij. The display discharge pulse is a pulse with a negative voltage −Vs and a positive voltage Vs. The number of times of light emission caused by the display discharge pulse between the common electrode Xi and the scan electrode Yi (the duration of the display discharge period Ts) is different in each SF. This enables determination of the gradation value.

The address electrode Aj is not used in the display discharge period Ts and is thus preferably brought into a floating state in order to reduce the reactive power. However, the address electrode drive circuit 106 has difficulty bringing the address electrode Aj into a complete floating state and fails to bring the address electrode Aj to be lower than 0V. Therefore, the pulse supplied to the address electrode Aj is a pulse with a positive voltage Vs and 0V as illustrated in FIG. 4. Hereinafter, this will be described in more detail.

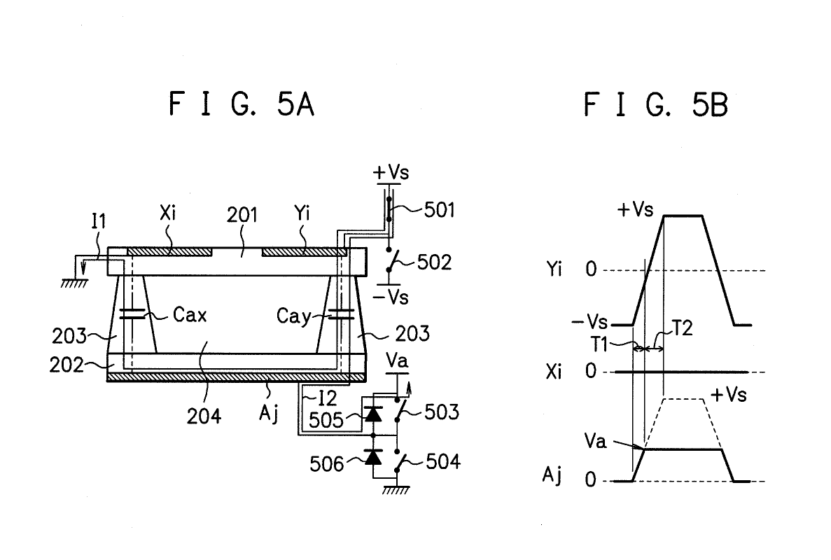

FIG. 5A is a circuit diagram illustrating a configuration example of the plasma display device, and FIG. 5B is a diagram of voltage waveforms of the scan electrode Yi, the common electrode Xi and the address electrode Aj in the display discharge period Ts. FIG. 5A will illustrate below components added to FIG. 2. The operation in the display discharge period Ts will also be described. A case where the capacitance values of the capacitances Cax and Cay are identical will be described. The common electrode Xi is connected to a node at the ground potential. The common electrode Xi keeps 0V.

Switches 501 and 502 are provided in the display discharge circuit 104 in the scan electrode drive circuit 107 in FIG. 1. The switch 501 is connected between the scan electrode Yi and a node at the positive voltage +Vs. The switch 502 is connected between the scan electrode Yi and a node at the negative voltage −Vs. When the switch 501 is turned on and the switch 502 is turned off, the positive voltage +Vs is applied to the scan electrode Yi. Conversely, when the switch 501 is turned off and the switch 502 is turned on, the negative voltage −Vs is applied to the scan electrode Yi.

Switches 503 and 504 and diodes 505 and 506 are provided in the address electrode drive circuit 106 in FIG. 1. The switch 503 is connected between the address electrode Aj and a node at a positive power supply voltage Va. The switch 504 is connected between the address electrode Aj and a node at the ground potential. The diode 505 has an anode connected to the address electrode Aj and a cathode connected to the node at the positive power supply voltage Va. The diode 506 has an anode connected to the node at the ground potential and a cathode connected to the address electrode Aj. In the address period Ta in FIG. 3, an address pulse with the positive power supply voltage Va and 0V can be generated by controlling the switches 503 and 504. In the display discharge period Ts, the switches 503 and 504 are off.

In a period T1 in FIG. 5B, the switch 502 is turned off and the switch 501 is turned on. Then, the voltage of the scan electrode Yi starts to rise from the negative voltage −Vs toward the positive voltage Vs. A current I1 flows from the node at the positive voltage +Vs to the node at the ground potential via the capacitance Cay, the address electrode Aj and the capacitance Cax. As illustrated by a broken line in FIG. 5B, the voltage of the address electrode Aj tries to rise from 0V to the positive voltage Vs with the voltage rise of the scan electrode Yi. However, when the voltage of the address electrode Aj reaches the positive power supply voltage Va, a current I2 flows from the node at the positive voltage +Vs to the node at the positive power supply voltage Va via the capacitance Cay, the address electrode Aj and the diode 505 in a period T2. As a result, the address electrode Aj keeps the positive power supply voltage Va. The current I2 generates reactive power. Hence, it is necessary to reduce the reactive current I2.

As described above, the plasma display device has a capacitive component composed of the capacitance Cxy between the common electrode Xi and the scan electrode Yi, the capacitance Cax between the common electrode Xi and the address electrode Aj, and the capacitance Cay between the scan electrode Yi and the address electrode Aj. The power applied when charging/discharging the capacitances is power consumed irrespective of the brightness of a screen, that is, the reactive power. Most of the reactive power is caused by the repeatedly applied display discharge pulse. In the display discharge period Ts, an alternating potential difference needs to be generated between the common electrode Xi and the scan electrode Yi, and it cannot be help to charge/discharge into/from the capacitance Cxy. Meanwhile, charge/discharge into/from the capacitances Cay and the Cax is not always necessary in the display discharge period Ts and can be reduced depending on the application condition of the voltage waveforms. More specifically, the voltage of the address electrode Aj will operate in an amplitude half the amplitude of the display discharge pulse for the scan electrode Yi as illustrated in FIG. 4.

Meanwhile, the maximum value and the minimum value of the voltage of the address electrode Aj are determined depending on the withstand voltage of the address electrode drive circuit 106. Therefore, in order to make the voltage of the address electrode Aj have a high voltage amplitude such as the amplitude half the amplitude of the display discharge pulse, it is necessary to increase the withstand voltage of the address electrode drive circuit 106 and to bring the address electrode drive circuit 106 into the floating state. As the next best approach, by changing the voltage of the address electrode Aj in synchronization with the display discharge pulse in a range of the withstand voltage in place of increasing the withstand voltage of the address electrode drive circuit 106, the reactive power can be reduced. However, the backflow I2 to the node at the positive power supply voltage Va of the address electrode Aj is caused. Therefore, a system for regenerating the power becomes necessary, resulting in increased cost. The period T1 in which the voltage of the scan electrode Yi changes from the negative voltage −Vs to the positive voltage +Vs and, in synchronization with the change, the voltage of the address electrode Aj changes from 0V to the positive power supply voltage Va in FIG. 5B will be described. When the address electrodes Aj is in the complete floating state, the voltage of the address electrode Aj changes from 0V to the positive voltage +Vs due to capacitive coupling of the capacitance Cay between the scan electrode Yi and the address electrode Aj and the capacitance Cax between the common electrode Xi and the address electrode Aj. Actually, to prevent exceeding the withstand voltage of the address electrode drive circuit 106, the maximum voltage of the address electrode drive circuit 106 is limited to the positive power supply voltage Va. Therefore, the current I2 charging the capacitance Cay flows from the scan electrode Yi to the address electrode Aj in the period T2 in which the voltage of the address electrode Aj is the positive power supply voltage Va or higher. A power regenerating circuit for effectively using the power is necessary. A case where the voltage of the scan electrode Yi changes from the negative voltage −Vs to the positive voltage +Vs and, in synchronization with the change, the voltage of the address electrode Aj changes from 0V to the positive power supply voltage Va will be described. As in the above description, at the point in time when the voltage of the address electrode Aj is 0V or lower, the current charging the capacitance Cay flows from the address electrode Aj to the scan electrode Yi. This power is supplied from the node at the negative voltage −Vs, resulting in increased reactive power.

Hereinafter, the plasma display device capable of suppressing the backflow I2 to the node at the positive power supply voltage Va of the address electrode Aj to reduce the reactive power will be described.

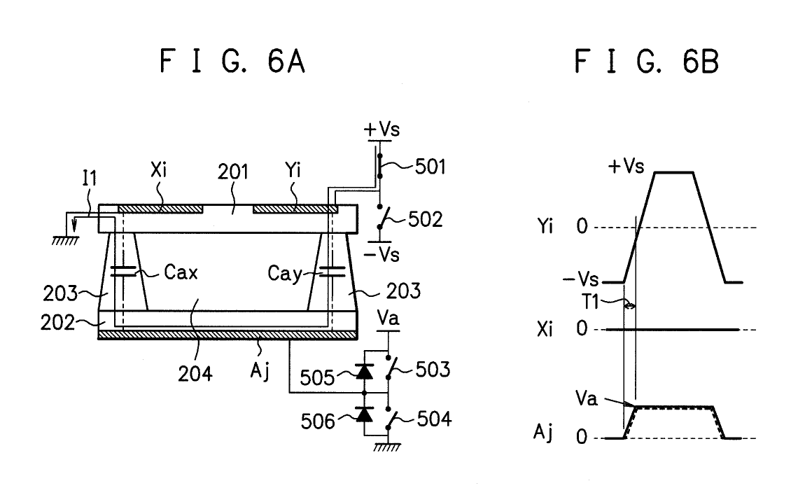

FIG. 6A is a diagram illustrating a configuration example of the plasma display device according to the first embodiment of the present invention, and FIG. 6B is a diagram of voltage waveforms of the scan electrode Yi, the common electrode Xi and the address electrode Aj in the display discharge period Ts. The capacitance values of the capacitance Cax and the capacitance Cay are identical in the plasma display device in FIG. 5A. In contrast, the capacitance values of the capacitance Cax and the capacitance Cay are different in the plasma display device in FIG. 6A. Hereinafter, the points of the plasma display device in FIGS. 6A and 6B different from the plasma display device in FIGS. 5A and 5B.

By setting an appropriate value for the ratio between the capacitance Cay between the scan electrode Yi and the address electrode Aj and the capacitance Cax between the common electrode Xi and the address electrode Aj, it is realized to reduce the reactive power and suppress the backflow 12 (FIG. 5A) to the node at the positive power supply voltage Va of the address electrode Aj while avoiding an increase in withstand voltage of the address electrode drive circuit 106. In a state where the positive voltage +Vs is being applied to the scan electrode Yi with the potential of the address electrode Aj in a floating state, the potential Va (Vs) of the address electrode Aj is expressed by the following expression (1).

$$\begin{matrix}[ Expression 1 ] & \\ Va ( Vs ) = \frac{Cay}{Cay + Cax} Vs & ( 1 )\end{matrix}$$

In a state where the negative voltage −Vs is being applied to the scan electrodes Yi, the potential Va (−Vs) of the address electrode Aj is expressed by the following expression (2).

$$\begin{matrix}[ Expression 2 ] & \\ Va ( - Vs ) = - \frac{Cay}{Cay + Cax} Vs & ( 2 )\end{matrix}$$

Therefore, assuming that the withstand voltage (set voltage) of the address electrode drive circuit 106 is Vamax, the following expression (3) is established.

$$\begin{matrix}[ Expression 3 ] & \\ Va max > 2 Va ( Vs ) = \frac{2 Cay}{Cay + Cax} Vs & ( 3 )\end{matrix}$$

It is only necessary to select the combination of the capacitances Cay and Cax satisfying the expression (3). Assuming that Vs=200V and Va=65V here, the following expression (4) is established.

$$\begin{matrix}[ Expression 4 ] & \\ Cay < \frac{Va}{2 Vs - Va} Cax = \frac{13}{67} Cax \approx \frac{1}{5} Cax & ( 4 )\end{matrix}$$

From the expression (4), it becomes necessary to set the capacitance Cay to ⅕ of the capacitance Cax. Further, a resultant capacitance Cp of the plasma display panel 101 when the address electrode Aj is in the floating state is expressed as the following expression (5).

$$\begin{matrix}[ Expression 5 ] & \\ Cp = Cxy + \frac{CayCax}{Cay + Cax} = Cxy + \frac{Cay}{\frac{Cay}{Cax} + 1} & ( 5 )\end{matrix}$$

If the capacitance Cay in FIG. 6A is identical to the capacitance Cay in FIG. 5A, it is possible to reduce the reactive power by making the capacitance Cax larger than the capacitance Cay.

As described above, it is only necessary that the capacitance Cax is larger than the capacitance Cay. Preferably, the capacitance Cax is five times the capacitance Cay or more. A broken line of the address electrode Aj in FIG. 6B indicates the voltage to be supplied from the scan electrode Yi to the address electrode Aj when the capacitance Cax is five times the capacitance Cay. The voltage is suppressed to the positive power supply voltage Va or lower and is therefore substantially the same as the actual voltage indicated by a solid line of the address electrode Aj. As a result, the backflow 12 illustrated in FIG. 5B can be suppressed to prevent the reactive power due to the backflow 12 in the period T2.

As described above, the common electrode Xi is supplied with a constant voltage in the display discharge period Ts. The scan electrode Yi is provided in parallel to the common electrode Xi, and supplied with the display discharge pulse to perform display discharge between the scan electrode Yi and the common electrode Xi in the display discharge period Ts. The address electrode Aj is provided in a manner to intersect the common electrode Xi and the scan electrode Yi. The capacitance Cax between the common electrode Xi and the address electrode Aj is larger than the capacitance Cay between the scan electrode Yi and the address electrode Aj.

From the expression (4), the ratio of the capacitance Cay between the scan electrode Yi and the address electrode Aj to the capacitance Cax between the common electrode Xi and the address electrode Aj is preferably Va/(2×Vs−Va) or lower where the voltage to be applied between the common electrode Xi and the scan electrode Yi in the display discharge period Ts is Vs and the voltage to be applied to the address electrode Aj in the address period Ta is Va.

According to this embodiment, it is possible to prevent an increase in cost caused by increasing the withstand voltage of the address electrode drive circuit 106 and to prevent an increase in cost caused by bringing the address electrode drive circuit 106 into a complete floating state. Consequently, this embodiment can reduce the reactive power even if the address electrode drive circuit 106 is not increased in withstand voltage and is not brought into a complete floating state.

### Second Embodiment

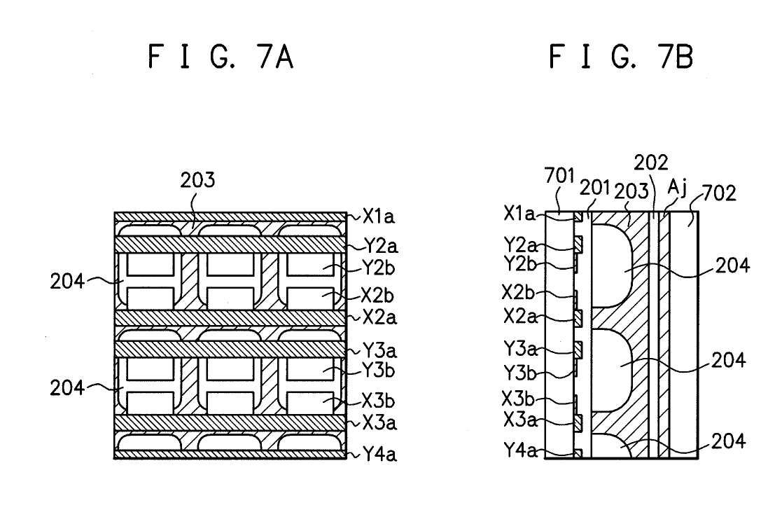

FIG. 7A is a plan view illustrating a configuration example of a plasma display device according to a second embodiment of the present invention, and FIG. 7B is a sectional view of the plasma display device. This embodiment illustrates a concrete configuration example of the plasma display device of the first embodiment.

A metal common electrode X1a is connected to a transparent common electrode, and they correspond to the first common electrode X1. A metal scan electrode Y2a and a transparent scan electrode Y2b are connected to each other and correspond to the second scan electrode Y2. A metal common electrode X2a and a transparent common electrode X2b are connected to each other and correspond to the second common electrode X2. A metal scan electrode Y3a and a transparent scan electrode Y3b are connected to each other and correspond to the third scan electrode Y3. A metal common electrode X3a and a transparent common electrode X3b are connected to each other and correspond to the third common electrode X3. A metal scan electrode Y4a is connected to a transparent scan electrode, and they correspond to the fourth scan electrode Y4. The second scan electrode Y2 performs display discharge between the second scan electrode Y2 and the second common electrode X2. The third scan electrode Y3 performs display discharge between third scan electrode Y3 and the third common electrode X3.

The common electrodes Xi and the scan electrodes Yi are formed on a front glass substrate 701. Thereon, a dielectric film 201 for insulating them from discharge spaces 204 is deposited. Meanwhile, the address electrodes Aj are formed on a rear glass substrate 702 disposed opposite the front glass substrate 701. Thereon, a dielectric film 202 is deposited. On the inner surface of a rib 203, a phosphor of red, blue and green is applied for each display cell. The phosphor is exited by a discharge between the common electrode Xi and the scan electrode Yi to generate light of each color. A Ne+Xe Penning gas or the like is sealed in the discharge spaces 204 between the front glass substrate 701 and the rear glass substrate 702.

The common electrode Xi is supplied with a constant voltage (for example, 0V) in the display discharge period Ts. The scan electrode Yi is provided in parallel to the common electrode Xi, and supplied with the display discharge pulse to perform display discharge between the scan electrode Yi and the common electrode Xi in the display discharge period Ts. The address electrode Aj is provided in a manner to intersect the common electrode Xi and the scan electrode Yi.

The rib 203 is provided between the common electrode Xi and the scan electrode Yi and the address electrode Aj, provided in parallel to the common electrode Xi to overlap a part of the common electrode Xi, and provided not to overlap the scan electrode Yi.

The capacitance Cax between the common electrode Xi and the address electrode Aj and the capacitance Cay between the scan electrode Yi and the address electrode Aj are expressed by ∈×S/d where E is the dielectric constant, S is the area of electrodes, and d is the distance between two electrodes.

The rib 203 is provided above the common electrode Xi, and the discharge space 204 is provided above the scan electrode Yi. The rib 203 is, for example, low-melting glass and has a relative dielectric constant ∈r of 7 to 8. The discharge space 204 is composed of, for example, a discharge gas Ne+Xe and has a relative dielectric constant ∈r of 1.

The dielectric constant ∈ of the rib 203 between the common electrode Xi and the address electrode Aj is larger than the dielectric constant ∈ of the discharge space 204 between the scan electrode Yi and the address electrode Aj. Accordingly, the capacitance Cax between the common electrode Xi and the address electrode Aj is larger than the capacitance Cay between the scan electrode Yi and the address electrode Aj. Consequently, this embodiment can achieve the effect similar to that of the first embodiment.

As described above, this embodiment has a configuration in which the rib 203 exists at a portion overlapping the common electrode Xi and the rib 203 does not exist above the scan electrode Yi. As the arrangement of the electrodes, the common electrodes Xi and the scan electrodes Yi are alternately arranged. In this case, the rib 203 existing above the common electrodes Xi separates display cells Pij.

### Third Embodiment

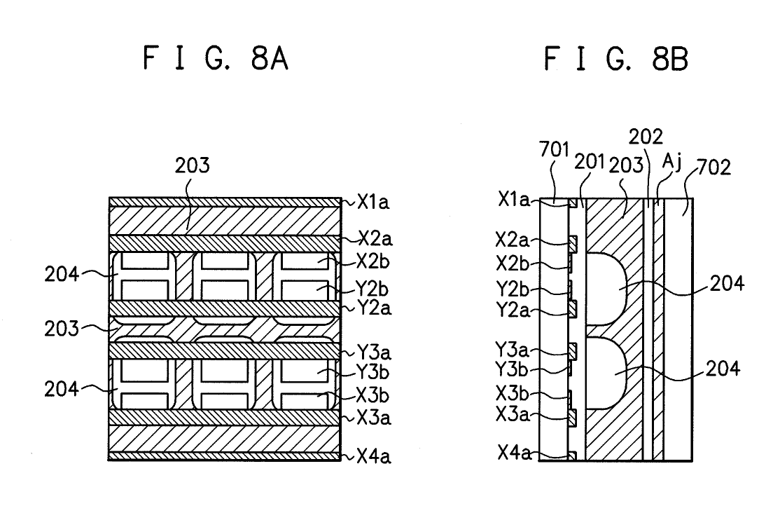

FIG. 8A is a plan view illustrating a configuration example of a plasma display device according to a third embodiment of the present invention, and FIG. 8B is a sectional view of the plasma display device. This embodiment illustrates a concrete configuration example of the plasma display device of the first embodiment. Hereinafter, points of this embodiment different from the second embodiment will be described.

In this embodiment, sets of two common electrodes Xi and sets of two scan electrodes Yi are alternately disposed as the arrangement of electrodes. The rib 203 separating the display cells Pij for the scan electrodes Yi is provided between the adjacent scan electrodes Yi, whereas the rib 203 for the common electrodes is provided above the two adjacent common electrodes Xi.

The metal common electrode X1a is connected to a transparent common electrode, and they correspond to the first common electrode X1. The metal common electrode X2a and the transparent common electrode X2b are connected to each other and correspond to the second common electrode X2. The metal scan electrode Y2a and the transparent scan electrode Y2b are connected to each other and correspond to the second scan electrode Y2. The metal scan electrode Y3a and the transparent scan electrode Y3b are connected to each other and correspond to the third scan electrode Y3. The metal common electrode X3a and the transparent scan electrode X3b are connected to each other and correspond to the third common electrode X3. The metal common electrode X4a is connected to a transparent common electrode, and they correspond to the fourth common electrode X4. The second common electrode X2 performs display discharge between the second common electrode X2 and the second scan electrode Y2. The third scan electrode Y3 performs display discharge between the third scan electrode Y3 and the third common electrode X3.

The rib 203 is provided between the common electrode Xi and the scan electrode Y1 and the address electrode Aj, provided in parallel to the common electrode Xi to overlap a part of the common electrode Xi, and provided not to overlap the scan electrode Yi.

The rib 203 is provided above the common electrode Xi, and the discharge space 204 is provided above the scan electrode Yi. The dielectric constant ∈ of the rib 203 between the common electrode Xi and the address electrode Aj is larger than the dielectric constant ∈ of the discharge space 204 between the scan electrode Yi and the address electrode Aj. Accordingly the capacitance Cax between the common electrode Xi and the address electrode Aj is larger than the capacitance Cay between the scan electrode Yi and the address electrode Aj. Consequently, this embodiment can achieve the effect similar to that of the first embodiment.

### Fourth Embodiment

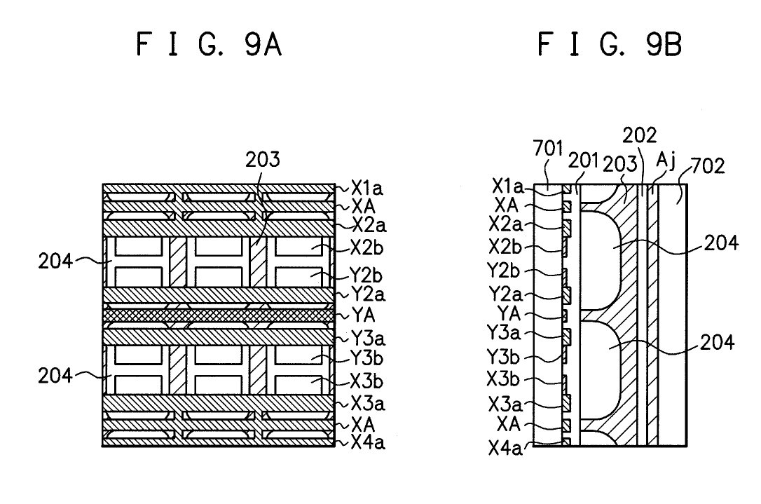

FIG. 9A is a plan view illustrating a configuration example of a plasma display device according to a fourth embodiment of the present invention, and FIG. 9B is a sectional view of the plasma display device. This embodiment illustrates a concrete configuration example of the plasma display device of the first embodiment. Hereinafter, points of this embodiment different from the third embodiment will be described.

The rib 203 is provided between the common electrode Xi and the scan electrode Yi and the address electrode Aj, provided between the two adjacent common electrodes Xi, and provided between the two adjacent scan electrodes Yi. The dielectric constant ∈ of the dielectric between the common electrode Xi and the address electrode Aj is identical to the dielectric constant ∈ of the dielectric between the scan electrode Yi and the address electrode Aj.

The first common electrode X1 is supplied with the constant voltage (0V) in the display discharge period Ts. The first scan electrode Y1 (FIG. 1) is provided in parallel to the first common electrode X1 and supplied with the display discharge pulse to perform display discharge between the first scan electrode Y1 and the first common electrode X1 in the discharge display period Ts. The second common electrode X2 is adjacent to the first common electrode X1 opposite the first scan electrode Y1 and provided in parallel to the first common electrode X1, and supplied with the constant voltage in the display discharge period Ts. The second scan electrode Y2 is provided in parallel to the second common electrode X2 and supplied with the display discharge pulse in the display discharge period Ts to perform display discharge between the second scan electrode Y2 and the second common electrode X2. The third scan electrode Y3 is adjacent to the second scan electrode Y2 opposite the second common electrode X2 and provided in parallel to the second scan electrode Y2, and supplied with the display discharge pulse in the display discharge period Ts. The third common electrode X3 is provided in parallel to the third scan electrode Y3 and supplied with the constant voltage in the display discharge period Ts to perform display discharge between the third common electrode X3 and the third scan electrode Y3.

A first light shield XA made of metal is provided between the first common electrode X1 and the second common electrode X2 and electrically connected to the first common electrode X1 and the second common electrode X2. In other words, the first light shield X1 is provided between two adjacent common electrodes Xi and electrically connected to the two adjacent common electrodes Xi.

A second light shield YA is provided between the second scan electrode Y2 and the third scan electrode Y3, and not electrically connected to the second scan electrode Y2 and the third scan electrode Y3 but separated from them. In other words, the second light shield YA is provided between two adjacent scan electrodes Yi and not electrically connected to the two adjacent scan electrodes Yi. The second light shield YA is, for example, a light shield made of insulator or metal.

The address electrode Aj is provided in a manner to intersect the common electrode Xi and the scan electrode Yi.

The capacitance Cax between the common electrode Xi and the address electrode Aj and the capacitance Cay between the scan electrode Yi and the address electrode Aj are expressed by ∈×S/d where ∈ is the dielectric constant, S is the area of electrodes, and d is the distance between two electrodes.

The common electrode Xi is electrically connected to the first light shield XA made of metal, so that the common electrode Xi has a large area S. In contrast, the scan electrode Yi is not electrically connected to the second light shield YA, so that the scan electrode Yi has an area S smaller than that of the common electrode Xi.

The area S of the common electrode Xi is larger than the area S of the scan electrode Yi. Therefore, the capacitance Cax between the common electrode Xi and the address electrode Aj is larger than the capacitance Cay between the scan electrode Yi and the address electrode Aj. Consequently, this embodiment can achieve the effect similar to that of the first embodiment.

To make the capacitance Cax larger than the capacitance Cay, the second light shield YA does not need to be provided. However, without the second light shield YA, light is blocked by the first light shield XA between the two adjacent common electrodes Xi, whereas light is not blocked between two adjacent scan electrodes Yi, resulting in uneven display. The second light shield YA has the function of blocking light like the first light shield XA and therefore can prevent the uneven display and prevent deterioration of image quality.

As described above, sets of two common electrodes Xi and sets of two scan electrodes Yi are alternately disposed, and the rib 203 is disposed between the electrodes in this embodiment. The first light shield XA is a metal light shield that is disposed to overlap the rib 203 between the two adjacent common electrodes Xi and connected to the two adjacent common electrodes Xi. The second light shield YA is an insulator or unconnected metal that is disposed to overlap the rib 203 between the two adjacent scan electrodes Yi.

### Fifth Embodiment

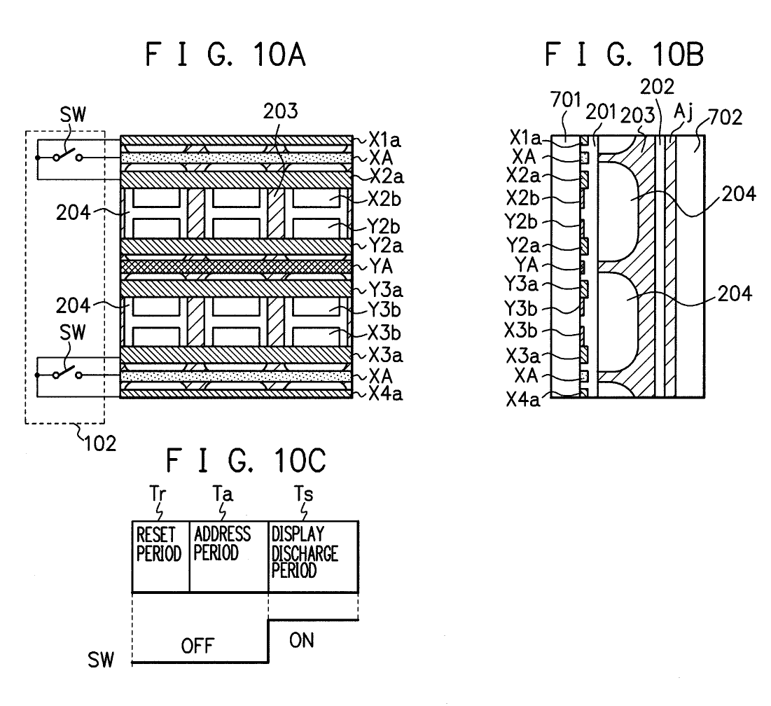

FIG. 10A is a plan view illustrating a configuration example of a plasma display device according to a fifth embodiment of the present invention, and FIG. 10B is a sectional view of the plasma display device. This embodiment illustrates a concrete configuration example of the plasma display device of the first embodiment. Hereinafter, points of this embodiment different from the fourth embodiment will be described.

The first light shield XA made of metal is provided between the first common electrode X1 and the second common electrode X2. The common electrode drive circuit 102 has a switch SW.

FIG. 10C is a diagram illustrating the operation of the switch SW. The switch SW is turned off in the reset period Tr and the address period Ta, and is turned on in the display discharge period Ts. More specifically, the switch SW electrically connects the first light shield XA to the first common electrode X1 (the third common electrode X3) and the second common electrode X2 (the fourth common electrode X4) in the display discharge period Ts, and electrically cuts the first light shield XA from the first common electrode X1 (the third common electrode X3) and the second common electrode X2 (the fourth common electrode X4) in the reset period Tr and the address period Ta.

The first light shield XA is electrically connected to the first common electrode X1 (the third common electrode X3) and the second common electrode X2 (the fourth common electrode X4) at least in the display discharge period Ts.

When the switch SW is turned on, the configuration of this embodiment becomes identical to that of the fourth embodiment, so that the same effect of the fourth embodiment can be achieved. When the switch SW is turned off in the reset period Tr and the address period Ta, the capacitance Cax between the common electrode Xi and the address electrode Aj can be made smaller to reduce the reactive power.

As described above, sets of two common electrodes Xi and sets of two scan electrodes Yi are alternately disposed, and the rib 203 is disposed between the electrodes in this embodiment. The first light shield XA is a metal that is disposed to overlap the rib 203 between the two adjacent common electrodes Xi. The second light shield YA is an insulator or unconnected metal that is disposed to overlap the rib 203 between two adjacent scan electrodes Yi. The first light shield XA is controlled by the switch SW to be brought to the same potential as that of the common electrode Xi in the display discharge period Ts and to be brought into a floating state in the reset period Tr and the address period Ta.

### Sixth Embodiment

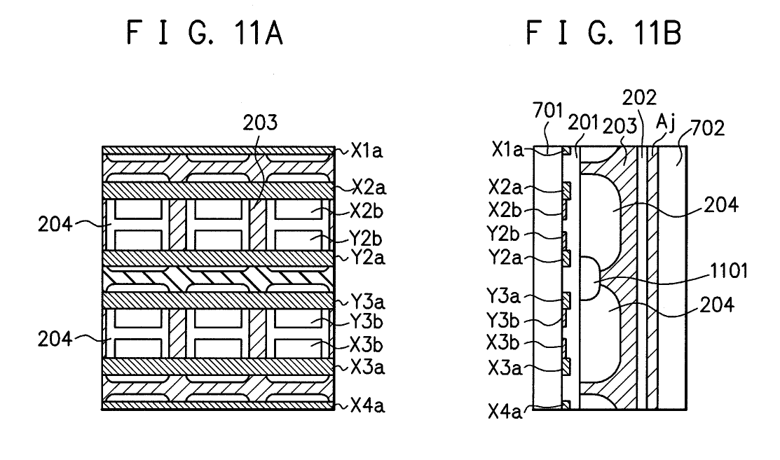

FIG. 11A is a plan view illustrating a configuration example of a plasma display device according to a sixth embodiment of the present invention, and FIG. 11B is a sectional view of the plasma display device. This embodiment illustrates a concrete configuration example of the plasma display device of the first embodiment. Hereinafter, points of this embodiment different from the third embodiment will be described.

Above two adjacent scan electrodes Yi, the rib 203 is removed and a space 1101 is provided. The space 1101 connects two adjacent discharge spaces 204. The rib 203 is provided between the common electrode Xi and the scan electrode Yi and the address electrode Aj such that the height of the rib 203 at a position corresponding to the scan electrode Yi is lower than the height of the rib 203 at a position corresponding to the common electrode Xi.

The space 1101 is provided above the two adjacent scan electrodes Yi, and the rib 203 is provided above the two adjacent common electrodes Xi. The dielectric constant ∈ of the rib 203 between the common electrode Xi and the address electrode Aj is larger than the dielectric constant ∈ of the space 1101 between the scan electrode Yi and the address electrode Aj. Accordingly, the capacitance Cax between the common electrode Xi and the address electrode Aj is larger than the capacitance Cay between the scan electrode Yi and the address electrode Aj. Consequently, this embodiment can achieve the effect similar to that of the first embodiment.

As described above, sets of two common electrodes Xi and sets of two scan electrodes Yi are alternately disposed, and the rib 203 is disposed between the electrodes in this embodiment. The rib 203 on the scan electrode Yi side is lower than the rib 203 on the common electrode Xi side.

### Seventh Embodiment

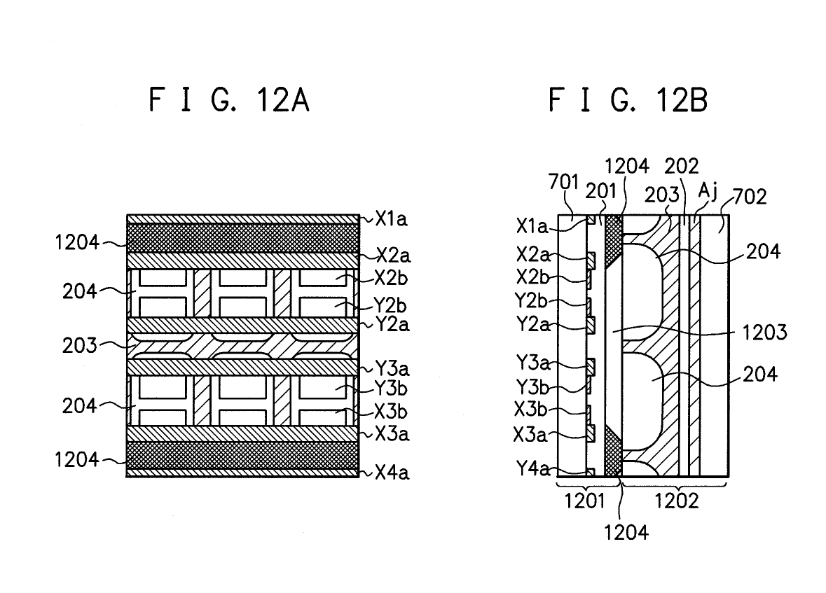

FIG. 12A is a plan view illustrating a configuration example of a plasma display device according to a seventh embodiment of the present invention, and FIG. 12B is a sectional view of the plasma display device. This embodiment illustrates a concrete configuration example of the plasma display device of the first embodiment. Hereinafter, points of this embodiment different from the third embodiment will be described.

The rib 203 is provided between the common electrode Xi and the scan electrode Yi and the address electrode Aj, provided between two adjacent common electrodes Xi, and provided between two adjacent scan electrodes Yi. The dielectric constant ∈ of the dielectric between the common electrode Xi and the address electrode Aj is identical to the dielectric constant ∈ of the dielectric between the scan electrode Yi and the address electrode Aj.

Above the common electrode Xi, a dielectric film 1204 is provided on the dielectric film 201. The dielectric film 1204 is provided on the dielectric film 201, so that the film thickness of the dielectric film becomes larger. In contrast, above the scan electrode Yi, a space 1203 is provided on the dielectric film 201. The space 1203 connects two adjacent discharge spaces 204.

The total film thickness of the dielectric films 201 and 1204 above the common electrode Xi is larger than the film thickness of the dielectric film 201 above the scan electrode Yi. More specifically, the dielectric film is provided so that the thickness of the films covering the common electrode Xi is larger than the thickness of the film covering the scan electrode Yi. The dielectric films 201 and 1204 are, for example, low-melting glass and have a relative dielectric constant ∈r of 7 to 8.

The space 1203 is provided above the scan electrode Yi and the dielectric film 1204 is provided above the common electrode Xi. The dielectric constant ∈ of the dielectric film 1204 between the common electrode Xi and the address electrode Aj is larger than the dielectric constant ∈ of the space 1203 between the scan electrode Yi and the address electrode Aj. Accordingly, the capacitance Cax between the common electrode Xi and the address electrode Aj is larger than the capacitance Cay between the scan electrode Yi and the address electrode Aj. Consequently, this embodiment can achieve the effect similar to that of the first embodiment.

A front substrate 1201 has the front glass substrate 701, the common electrodes Xi, the scan electrodes Yi, the dielectric film 201, and the dielectric film 1204. A rear substrate 1202 has the rear glass substrate 702, the address electrodes Aj, the dielectric film 202, and the rib 203.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

### INDUSTRIAL APPLICABILITY

It is possible to reduce the reactive power due to the current flowing between the address electrode and the scan electrode in the display discharge period.

What is claimed is:

1. A plasma display device, comprising:
a first common electrode that is supplied with a constant voltage in a display discharge period;
a first scan electrode that is provided in parallel to said first common electrode and supplied with a display discharge pulse in the display discharge period to perform display discharge between said first scan electrode and said first common electrode; and
a first address electrode that is provided in a manner to intersect said first common electrode and said first scan electrode,
wherein the capacitance between said first common electrode and said first address electrode is larger than the capacitance between said first scan electrode and said first address electrode.

2. The plasma display device according to claim 1,
wherein the ratio of the capacitance between said first scan electrode and said first address electrode to the capacitance between said first common electrode and said first address electrode is Va/(2×Vs−Va) or lower where the voltage to be applied between said first common electrode and said first scan electrode in the display discharge period is Vs and the voltage to be applied to said first address electrode in the address period is Va.

3. The plasma display device according to claim 1, further comprising:
a rib that is provided between said first common electrode and said first scan electrode and said first address electrode, provided in parallel to said first common electrode to overlap a part of said first common electrode, and provided not to overlap said first scan electrode.

4. The plasma display device according to claim 1, further comprising:
a second common electrode that is adjacent to said first common electrode opposite said first scan electrode and provided in parallel to said first common electrode, and supplied with the constant voltage in the display discharge period;
a second scan electrode that is provided in parallel to said second common electrode and supplied with a display discharge pulse in the display discharge period to perform display discharge between said second scan electrode and said second common electrode;
a third scan electrode that is adjacent to said second scan electrode opposite said second common electrode and provided in parallel to said second scan electrode, and supplied with the display discharge pulse in the display discharge period;
a third common electrode that is provided in parallel to said third scan electrode and supplied with the constant voltage in the display discharge period to perform display discharge between said third common electrode and said third scan electrode;
a first light shield made of metal that is provided between said first common electrode and said second common electrode and electrically connected to said first common electrode and said second common electrode at least in the display discharge period; and
a second light shield that is provided between said second scan electrode and said third scan electrode and not electrically connected to said second scan electrode and said third scan electrode.

5. The plasma display device according to claim 4, further comprising:
a switch that electrically connects said first light shield to said first common electrode and said second common electrode in the display discharge period, and electrically cuts said first light shield from said first common electrode and said second common electrode in a reset period and an address period.

6. The plasma display device according to claim 1, further comprising:
a rib that is provided between said first common electrode and said first scan electrode and said first address electrode such that the height of said rib at a position corresponding to said first scan electrode is lower than the height of said rib at a position corresponding to said first common electrode.

7. The plasma display device according to claim 1, further comprising:
a dielectric film that is provided such that the thickness of said film covering said first common electrode is larger than the thickness of said film covering said first scan electrode.
